(19) United States
(12) Patent Application Publication
(10) Pub. No.: US 2005/0044721 A1
(43) Pub. Date: Mar. 3, 2005

(54) Scissors

(75) Inventors: Marta Phillips, Barrington, IL (US); David Mathieu, South Glastonbury, CT (US); Kirsten Paindiris, Hebron, CT (US); Chris Switalski, Suffield, CT (US)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Acme United Corporation

(21) Appl. No.: 10/910,953

(22) Filed: Aug. 4, 2004

Related U.S. Application Data
(60) Provisional application No. 60/492,532, filed on Aug. 5, 2003.

(51) Int. Cl. B26B 1/00

(52) U.S. Cl. 30/230; 30/195; 30/142

(57) ABSTRACT

A cutting implement for cutting a pattern in a substrate having a first cutting member and a second cutting member operatively connected to the first cutting member is provided. At least one of the first and second cutting members has two indicia of the pattern. A scissors for cutting a pattern in a substrate having a first patterned cutting blade partially covered by a first overmold shield and a second patterned cutting blade operatively connected to first blade and partially covered by a second overmold shield is provided. At least one of the first and the second overmold shields has visible indicia corresponding to the pattern. A method of making the scissors using a single insert molding step by molding the blades to the respective overmold shields and handles is also provided.

This application claims the benefit of U.S. Provisional Patent Application Ser. No. 60/492,532, filed on Aug. 5, 2003, the contents of which are incorporated by reference herein.

### BACKGROUND OF THE INVENTION

1. Field of the Invention

The present invention relates generally to a scissors that has indicia of the cut pattern of cutting edges of one or more blades of the scissors. Particularly, the present invention relates to a scissors that has a pair of blades, each blade with a patterned cutting edge or configuration that cuts such a pattern in a substrate, and the pattern is permanently visible on the scissors itself. More particularly, the present invention relates to a scissors that has a pair of blades, each blade with a patterned cutting edge that cuts such a pattern in a substrate, the pattern is permanently shown on the scissors, and the cutting edge is protected so that the user cannot inadvertently be cut by the cutting edges.

The present invention also relates to a single step manufacturing process for the cutting blade and handle assembly of the scissors.

2. Description of the Related Art

There are a number of prior art scissors that have cutting blade edges that have a pattern or patterned configuration. Such patterns are prominently visual as the unobstructed cutting edges of the blades. When one uses the scissors, extra care must be taken by the user because the pattern makes it more difficult to cut the substrate, such as paper. Thus, the user can more easily be cut or injured during the cutting process because the configured blade is unprotected. Furthermore, most, if not all, of these configured cutting edges, are for cutting by children so that the cutting edges are normally blunt and can primarily, if not solely, be used to cut thin paper.

There is a need for patterned cutting edges of blades that are relatively sharp so that they can easily cut a number of different substrates including thick paper and paper laminates, yet provide a safe visual identification of the cutting pattern.

Furthermore, there is a need for a single step manufacturing process for the cutting blade and handle assembly of the scissors.

### SUMMARY OF THE INVENTION

It is an object of the present invention to provide scissors having an indicator that provides a visual indication of the cutting edge of one or both blades of the scissors.

It is another object of the present invention to provide scissors in which such a visual indicator is formed as a part of the scissors.

It is yet another object of the present invention to provide a plastic indicator for at least one blade that is an indicator of the pattern that the blades will cut.

It is still another object of the present invention to provide a scissors having a plastic indicator that is visible to the user even when the cutting edges of the blades are not in view, such as in a closed position.

It is a further object of the present invention to provide a scissors that has a pair of blades with a patterned cutting edge or configuration that cuts such a pattern into a substrate, and a permanent visual indicator of the pattern is shown on the scissors itself.

It is still yet a further object of the present invention to provide lightweight, strong cutting blades of a scissors.

It is yet a further object of the present invention to provide a single step manufacturing process for the cutting blade and handle assembly of the scissors.

These and other objects and advantages are achieved by scissors of the present invention. The scissors has a first and a second handle and blade assembly that are connected together at a pivot. Each blade assembly has a blade shield and a handle preferably made of plastic and integrally formed together. Each blade assembly also has a cutting blade with a cutting blade surface having a patterned cutting edge. At least one of the blade shields has an indicator portion that is the indicator of the pattern of cutting edges. Both cutting blades do not project beyond the profile of blade shields so as to protect the user from inadvertently being cut during the cutting operation of the scissors.

### BRIEF DESCRIPTION OF THE DRAWINGS

The foregoing and still other objects and advantages of the present invention will be more apparent from the following detailed description of the preferred embodiments of the present invention in connection with the accompanying drawings.

FIG. 1 is a plan view of the scissors of the present invention;

FIG. 2 is a perspective view of the scissors of FIG. 1;

FIG. 3 is a cross sectional view taken along lines 3-3 of FIG. 1 of the scissors of FIG. 1;

FIG. 4 is an exploded view of the blade portion of the scissors of FIG. 1; and

FIG. 5 is a plan view of one-half of the scissors of FIG. 1.

### DETAILED DESCRIPTION OF THE INVENTION

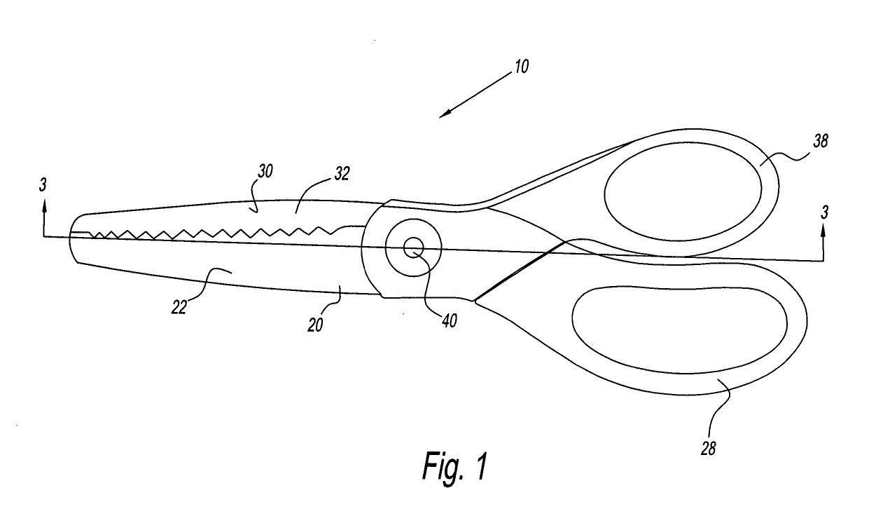

Referring to the drawings and, in particular, to FIG. 1, there is provided a scissors generally represented by reference numeral 10. The scissors 10 has a first handle and blade assembly 20 and a second handle and blade assembly 30 that are connected together at a pivot 40.

Pivot 40 can have any conventional pivot connection that permits first and second assemblies 20, 30 to pivot thereabout. Preferably, pivot 40 has two elements, a screw and a female receiving portion for the screw. A plastic cap preferably covers both pivot elements. Alternatively, pivot 40 could be a rivet with a blunted end or a female receiving member for the rivet. Both are preferably capped. The caps for each piece of pivot 40 may carry a logo.

First blade assembly 20 has a blade shield 22 and a handle 28. Preferably, blade shield 22 and handle 28 are made of plastic and are integrally formed together. Likewise, second assembly 30 has a blade shield 32 and a handle 38 that are preferably made of plastic and integrally formed together by a process such as injection molding, although other processes could be used.

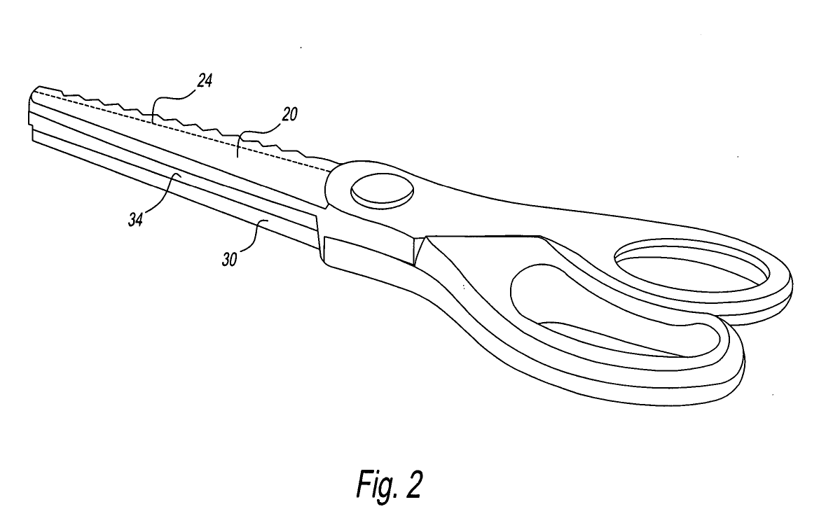

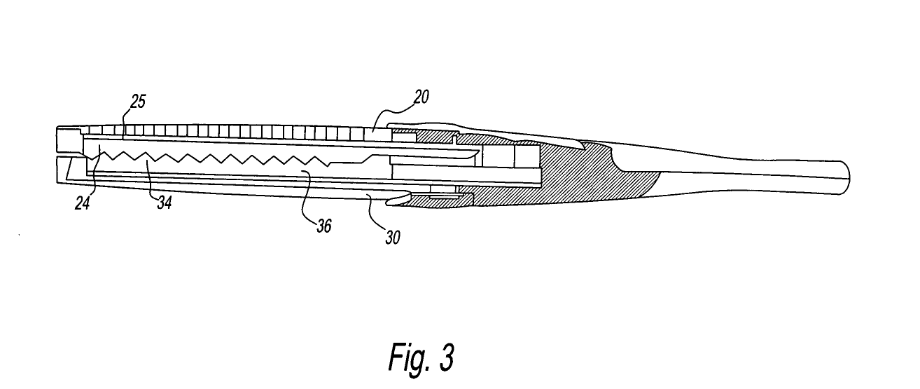

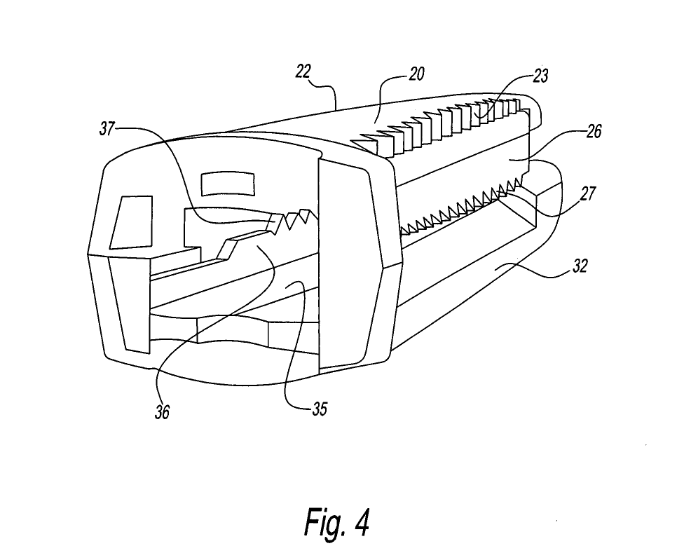

Referring to FIG. 2, first blade assembly 20 also has a cutting blade 24 and second blade assembly 30 also has a cutting blade 34. As shown in FIGS. 3 and 4, first blade assembly 20 also has a cutting blade 24 and second assembly 30 also has a cutting blade 34. Cutting blade 24 has a shaft 25 and a cutting blade surface 26 having a patterned cutting edge 27. Cutting blade surface 26 is also basically perpendicular to shaft 25. Likewise, cutting blade 34 has a shaft 35 and a cutting blade surface 36 having a patterned cutting edge 37. Cutting blade surface 36 is also basically perpendicular to shaft 35. The shafts 25, 35 are preferably aligned with and connected, preferably by glue, to blade shields 22, 32 that are also basically perpendicular to their respective patterned cutting edges 27, 37. Shields 22, 32 also extend beyond the profile of patterned cutting edges 27, 37 thereby shielding them from view, as shown in FIG. 2. Shields 22, 32 provide a protective function that is of particular importance because they will prevent inadvertent injury to children who will be the primary users of the scissors.

As shown in FIG. 4, cutting blades 24, 34 are configured so that patterned cutting edges 27, 37 face towards each other to mate to cut a substrate, such as paper. Cutting blades 24, 34, shown in the figures, illustrate one or several preferred cutting blade configurations. In the figures shown, cutting edges 27, 37 have a sinusoidal pattern.

In first blade assembly 20, blade shield 22 and handle 28 are integrally formed and extend past pivot 40 to the end of the blade 24. Likewise, in second blade assembly 30, blade 32 and handle 38 are integrally formed and extend beyond pivot 40 to the end of blade 34. In both assemblies 20, 30, the shields 22, 32 provide protection from the respective blades, 24, 34 and provide additional structural support to blades 24, 34.

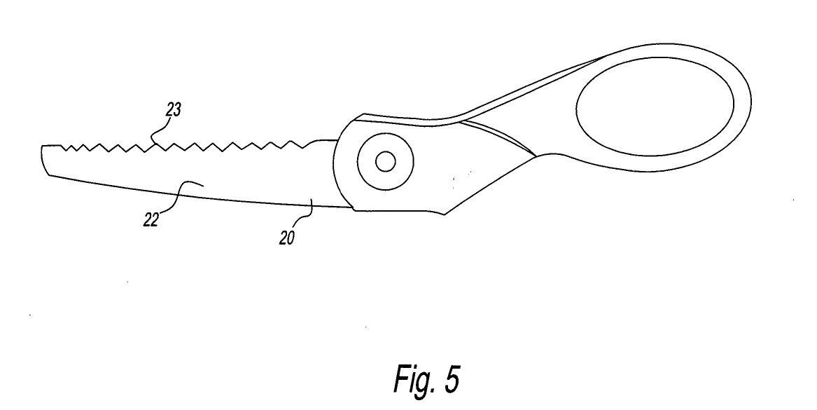

Referring to FIGS. 4 and 5, first blade assembly 20 has blade shield 22 with a profile 23. Profile 23 preferably corresponds to the configuration of patterned cutting edge 27, and thus provides a prominent visual indicator of the configuration of patterned cutting edge 27. The prominence of profile 23 acts as a visual indicator if scissors 10 are in either a closed or an opened configuration.

Profile 23 can have any pattern or configuration to provide to a potential purchaser or user with a clear indication of the cut that will be achieved by patterned cutting edges 27, 37 of scissors 10. Accordingly, this visual indicator is preferably made of the same material and molded as a part of first blade assembly 20. Second blade assembly 30 also has a blade shield 32 that shields patterned cutting edge 37 and may have a visual indicator of patterned cutting edge 37. Either blade shield 22 or blade shield 32 may act as a visual indicator of the configuration of patterned cutting edges 27, 37 or they both may have a prominent visual indicator.

Blade assemblies 20, 30 are preferably made of a hard plastic, preferably acrylonitrile-butadiene-styrene (ABS) polymer, polypropylene rubber (PPR) or nylon or other such similar material. At the handles 28, 38 where the fingers are inserted, there is an optional overmold of softer material of preferably a thermoplastic resin (TPR) or other such similar material that will offer a gripping function to the user's fingers.

Cutting blades 24, 34 of scissors 10 are preferably made of metal. The preferred metal is titanium or a non-titanium coated metal.

Scissors 10 can be manufactured in a one step process. Each cutting blade 24,34 is inserted into an injection mold and insert molded to form the plastic blade assemblies 20 and 30 around the blades. Each blade assembly 20, 30 extends the entire extent of the mold so that pivot 40 is merely a hole or area for connection towards the center of the molded assemblies.

The present invention has been described with particular reference to the preferred embodiment. It should be understood that the foregoing descriptions and examples are only illustrative of the present invention. Various alternatives, modifications and variations thereof can be devised by those skilled in the art without departing from and the spirit and scope of the present invention. Accordingly, the present invention is intended to embrace all such alternatives, modifications, and variations that fall within the scope the present invention.

1. A cutting implement for cutting a pattern in a substrate comprising;
a first cutting member; and
a second cutting member operatively connected to said first cutting member,
wherein at least one of said first and second cutting members has two indicia of the pattern.

2. The cutting implement according to claim 1, wherein said first and said second cutting members have two indicia of the pattern.

3. The cutting implement according to claim 1, wherein said first cutting member has a first blade with a first patterned cutting edge and a first longitudinal shaft perpendicular to said first patterned cutting edge; and
said second cutting member has a second blade with a second patterned cutting edge and a second longitudinal shaft perpendicular to said second cutting edge that corresponds to said first patterned cutting edge.

4. The cutting implement according to claim 3, wherein said first cutting member has a first overmold shield covering said first longitudinal shaft and said second cutting member has a second overmold shield covering said second longitudinal shaft.

5. The cutting implement according to claim 4, wherein at least one of said first and said second overmold shields has a patterned indicia corresponding to said first patterned cutting edge and said second patterned cutting edge.

6. The cutting implement according to claim 4, wherein said first and said second overmold shields have a patterned indicia corresponding to said first patterned cutting edge and said second patterned cutting edge.

7. The cutting implement according to claim 4, wherein said first cutting member further comprises a first handle and said second cutting member comprises a second handle.

8. The cutting implement according to claim 7, wherein said first handle and said first overmold shield are molded to said first blade in a single molding step; and wherein said second handle and said second overmold shield are molded to said second blade in a single molding step.

9. The cutting implement according to claim 2, wherein when said first blade and said second blade are in a closed position, at least one of said overmold sheilds is visible to the user.

10. The cutting implement according to claim 3, wherein said first blade and said second blade are made from titanium or non-titanium coated metal.

11. The cutting implement according to claim 8, wherein said first handle and said first overmold shield and said second handle and said second overmold shield are molded from a material selected from the group consisting of acrylonitrile-butadiene-styrene polymer, polypropylene rubber, nylon, and any combinations thereof.

12. A scissors for cutting a pattern in a substrate comprising:
a first patterned cutting blade partially covered by a first overmold shield; and
a second patterned cutting blade operatively connected to said first blade and partially covered by a second overmold shield,
wherein at least one of said first and said second overmold shields has visible indicia corresponding to the pattern.

13. The scissors according to claim 12, wherein said first and said second overmold shields have visible indicia corresponding to the pattern.

14. The scissors according to claim 12, wherein said first overmold shield has an first integral handle and said second overmold shield has a second integral handle.

14. The scissors according to claim 12, wherein said first overmold shield covers a first longitudinal shaft perpendicular to said first cutting blade, and wherein said second overmold shield covers a second longitudinal shaft perpendicular to said second cutting blade.

15. The scissors according to claim 14, wherein said first handle and said first overmold shield are molded to said first longitudinal blade in a single molding step, and wherein said second handle and said second overmold shield are molded to said second longitudinal shaft in a single molding step.

16. The scissors according to claim 12, wherein when said first blade and said second blade in a closed position, at least one of said overmold shields is visible to the user.

17. A method of making a pair of scissors comprising:
placing a first cutting blade in a mold;
injecting plastic to fill an entire extent of the mold around said first cutting blade to form a first handle and a blade cover having a first central hole;
placing a second cutting blade in a mold;
injecting plastic to fill an entire extent of the mold around said second cutting blade to form a second handle and blade cover having a second central hole; and
connecting said first handle and blade cover to said second handle and blade cover with a pivot through said first central hole and said second central hole.

18. The method according to claim 17, wherein said blade is comprised of titanium or titanium coated metal.

19. The method according to claim 17, wherein said first handle and first blade cover, and wherein said second handle and second blade cover are made from made from a material selected from the group consisting of acrylonitrile-butadiene-styrene polymer, polypropylene rubber, nylon, and any combinations thereof.

20. The method according to claim 17, further comprising molding thermoplastic resin to said handles.
